(19) United States
(12) Patent Application Publication
(10) Pub. No.: US 2018/0126804 A1
(43) Pub. Date: May 10, 2018

(54) PNEUMATIC VEHICLE TIRE WITH A SOUND ABSORBER

(71) Applicant: Continental Reifen Deutschland GmbH, Hannover (DE)

(72) Inventors: Matthias Jacob, Leipzig (DE); Oliver Schuermann, Langenhagen (DE)

(21) Appl. No.: 15/861,453

(22) Filed: Jan. 3, 2018

Related U.S. Application Data
(63) Continuation of application No. PCT/EP2016/054261, filed on Mar. 1, 2016.

(30) Foreign Application Priority Data
Jul. 3, 2015 (DE) 102015212484.3

(51) Int. Cl. B60C 19/00; B29C 73/16

(52) U.S. Cl. CPC B60C 19/002; B29D 2030/0686; B29C 73/163

(57) ABSTRACT

The invention relates to a pneumatic vehicle tire having a sound absorber composed of foam which is adhesively attached, in the interior of the tire, to the inner surface situated opposite the tread, wherein the sound absorber adheres to a previously applied, self-sealing sealant which, at least immediately after its application, has a tackiness required for the adhesive attachment of the sound absorber. The sound absorber is made up of a multiplicity of individual geometric sound absorber bodies which are not connected to one another, in that each of the geometric sound absorber bodies adheres to the sealant, and in that each of the geometric sound absorber bodies has a diameter of 1 mm to 50 mm.

### CROSS REFERENCE TO RELATED APPLICATIONS

This application is a continuation application of international patent application PCT/EP2016/054261, filed Mar. 1, 2016, designating the United States and claiming priority from German application 10 2015 212 484.3, filed Jul. 3, 2015, and the entire content of both applications is incorporated herein by reference.

### FIELD OF THE INVENTION

The invention relates to a pneumatic vehicle tire having a sound absorber composed of foam which is adhesively attached, in the interior of the tire, to the inner surface situated opposite the tread, wherein the sound absorber adheres to a previously applied, self-sealing sealant which, at least immediately after its application, has a tackiness required for the adhesive attachment of the sound absorber.

### BACKGROUND OF THE INVENTION

Such a pneumatic vehicle tire is known from DE 10 2007 028 932 A1. The inner absorber is a ring composed of open-cell foam which reduces the vibration of air in the tire and leads to an improvement in the noise conditions in the vehicle. The high-viscosity sealant applied to the inner side of the tire has two functions: It seals an undesired puncture of the tire in the region of the tread, in that in the event of damage to the inner layer the viscous sealant flows into the location of the damage. Moreover, the sealant serves at the same time as an “adhesive agent” for securing the sound-absorbing foam ring.

However, the flow characteristics of the high-viscosity sealant may be adversely affected by the inner absorber lying on the sealant over its full surface area, meaning that the desired sealing effect occurs only after a delay or not at all. In cases in which the penetrating foreign body comes out of the tire again and leaves a large air channel, reliable sealing by the sealant adversely affected in terms of its flow characteristics is particularly difficult.

“Highly viscous” should be understood here as meaning a sealant of which the viscosity is more than 10 Pa·s.

### SUMMARY OF THE INVENTION

It is an object of the invention to improve the sealing of the tire in the event of punctures and at the same time improve the sound absorption. Furthermore, it is an object of the invention to provide a method for producing an aforementioned tire.

According to the invention, the stated object can, for example, be achieved, with regard to the vehicle tire, in that the sound absorber is made up of a multiplicity of individual geometric sound absorber bodies which are not connected to one another, in that each of the geometric sound absorber bodies adheres to the sealant, and in that each of the geometric sound absorber bodies has a diameter of 1 mm to 50 mm.

According to an aspect of the invention, the sound absorber is not a unipartite body which runs in encircling fashion over the tire circumference, it rather being the case that the sound absorber is composed of a multiplicity of individual sound absorber bodies which each adhere to the sealant arranged in annular fashion on the tire inner surface. The sound absorber bodies are arranged in one layer, in front of, behind and adjacent to one another and so as to be in contact and/or free from contact, in a manner adhesively bonded to the sealant arranged in annular fashion.

The surface area of the multiplicity of sound absorber bodies is, overall, normally much larger than the surface area of a single sound-absorbing ring, whereby the sound absorption is improved. By virtue of the fact that the sound absorber bodies, with suitable geometry, are adhesively bonded to the sealant not over their full surface area, with free sealant surface regions rather being ideally formed between the sound absorber bodies, the flow characteristics of the sealant in the event of punctures, and thus the sealing of the tire, are improved.

The diameter of a sound absorber body is measured on the basis of the smallest possible (imaginary) sphere enclosing the sound absorber body.

Sound absorber bodies of a suitable size are arranged in such a number that, in a projection onto the sound absorber bodies, 30-95%, preferably 70-90%, of the surface situated opposite the tread is covered with sound absorber bodies.

It is advantageous if the sound absorber bodies are geometrically regular bodies, such as spheres or polyhedra, which preferably have a diameter of 10 mm to 70 mm, preferably of 20 mm to 40 mm. Spheres have for example only a punctiform contact surface on the sealant, such that the contact surface of all spherical sound absorber bodies that form the sound absorber is ideally small. A large sealant surface that is not covered by the sound absorber is available. Therefore, the flowability of the sealant is greatly improved in relation to a foam ring lying over the full surface area.

In another embodiment of the invention, the sound absorber bodies are geometrically irregular bodies which preferably have a diameter of 10 mm to 70 mm, preferably of 20 mm to 40 mm. The sound absorber bodies have a larger adhesive surface than, for example, a spherical sound absorber body, whereby perfect setting of the balance between the sealing capability of the sealant and the adhesion of the sound absorber body is made possible through selection of the suitable diameter.

All sealants that are self-sealing and, at least immediately after application to the inner surface area of the tire, are tacky enough that the subsequently applied sound absorber can be adhesively bonded with the sealant come into consideration within the scope of the invention. Therefore, sealants based on polyurethane or sealants that are a viscous mixture based on a butyl rubber, a polybutene or based on silicone are for example suitable.

It is advantageous if the layer thickness of the sealant is between 2 mm and 5 mm, preferably approximately 3.5 mm. While providing reliable sealing in the event of punctures, the improved flow characteristics of the sealant make it possible to reduce the layer thickness of the sealant by 30%-50% in comparison with the layer thickness of the foam ring lying over the full surface area. This saves costs and also tire weight.

The sound absorber bodies within a tire are either of equal sizes or of different sizes, for example in order to realize as large a projected surface coverage as possible.

The method for producing a pneumatic vehicle tire with sealant and sound absorber as per an above-described vehicle tire can be performed easily and cost-effectively by means of the following steps:

arranging the annular sealant layer on the inner layer of the tire,

pouring a sufficient number of sound absorber bodies into the tire interior space,

rotating the tire such that the sound absorber bodies adhere to the annular sealant layer.

### BRIEF DESCRIPTION OF THE DRAWINGS

The invention will now be described with reference to the drawings wherein:

FIG. 1 shows a cross section through a pneumatic vehicle tire of the prior art; and,

FIG. 2 shows a cross section through a pneumatic vehicle tire according to the invention.

### DESCRIPTION OF THE PREFERRED EMBODIMENTS OF THE INVENTION

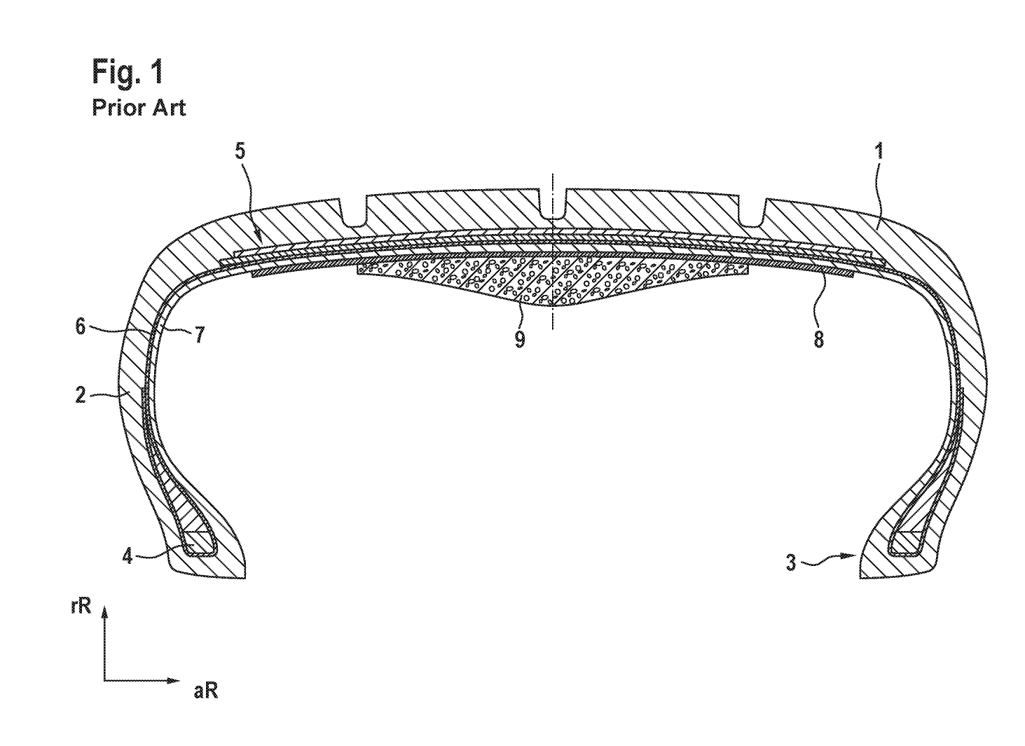

FIG. 1 depicts a cross section through a radial passenger motor vehicle tire having a profiled tread 1, sidewalls 2, bead regions 3, bead cores 4 and also a multi-ply belt assembly 5 and a carcass insert 6. On its inner surface, the tire is covered with an inner layer 7 of an airtight rubber compound. Applied to the inner surface of the inner layer 7, the inner surface being opposite from the tread 1, is a sealant 8 which in the event of puncture—tire damage—is capable of behaving in a self-sealing manner. Adhering to the sealant 8 over the full surface area is a unipartite annular inner absorber 9 assuming the function of a sound absorber, which, immediately after the application of the sealant 8, is pressed onto the sealant 8 while the latter is still sufficiently tacky, as will be described below. With respect to its sound-absorbing properties, the inner absorber 9 is tailored to the tire cavity frequency. The inner absorber 9 has here for example an approximately elongated triangular cross section that is symmetrical with respect to the axis of symmetry of the tire and which adheres by its bottom side to the sealant 8 over the full surface area. The foam of the inner absorber 9 is an open-cell foam, since this is best suited to absorbing sound. Possible sealants are, for example, polyurethane gels or viscous mixtures based on butyl rubbers, polybutenes or silicone, it being possible for the mixtures to contain the customary further constituents, such as plasticizer oils. The sealant is introduced, for example by spraying, such that it covers at least the inner surface situated opposite the tread 1. The tire can be rotated in order to optimally distribute the sealant on the inner surface. Furthermore, the sealant is introduced in such an amount that the layer thickness of the sealant is between 7 mm and 8 mm.

The sealant ought to be relatively liquid and tacky at least immediately after application. At this time, the prefabricated inner absorber 9 is introduced into the interior of the tire. After full reaction, the inner absorber 9 adheres to the sealant 8, which is elastically deformable but remains substantially immobile.

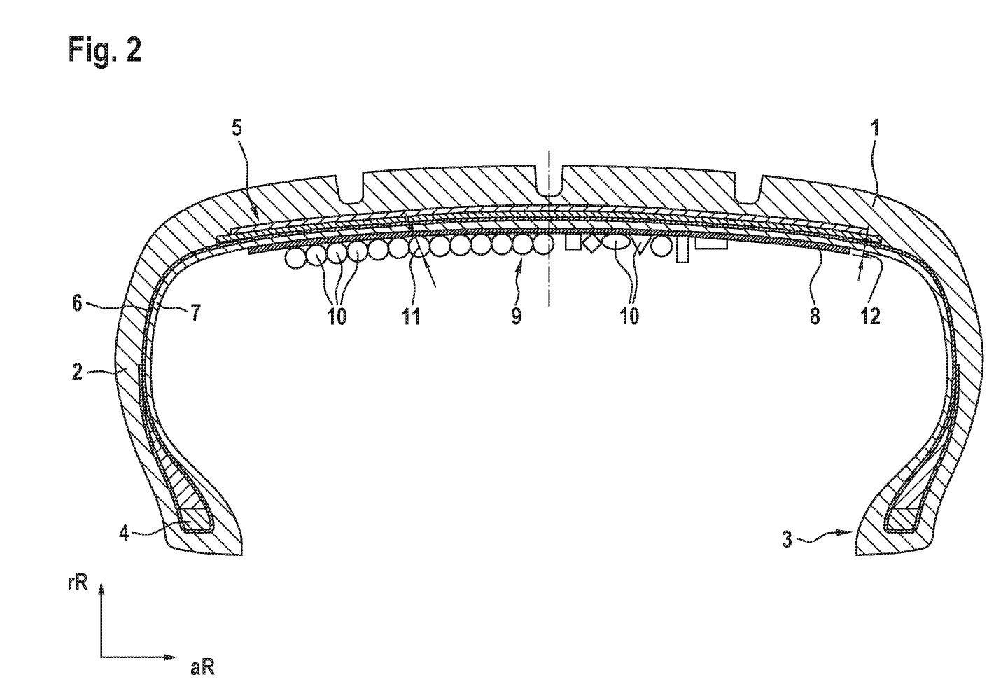

FIG. 2 shows a cross section through a pneumatic vehicle tire according to the invention for passenger motor vehicles, with dimensions 205/55 R16. The vehicle tire of FIG. 2 differs from the vehicle tire of FIG. 1 in that the sound absorber 9 is made up of a multiplicity of individual geometric sound absorber bodies 10 which are not connected to one another, which are in contact and/or which are free from contact. Sound absorber bodies 10 are arranged in such a number that, in a projection onto the sound absorber bodies, 30-95%, preferably 70-90%, of the surface situated opposite the tread is covered with sound absorber bodies. Here, the left-hand half of the cross section shows sound absorber bodies 10 of spherical form. Each of the geometric sound absorber bodies 10 adheres to the sealant 8. Each of the geometric sound absorber bodies 10 is of equal size and has a diameter 11 of 10 mm to 70 mm. The layer thickness 12 of the sealant 8 is very small and amounts to approximately 3.5 mm. Shown on the right-hand half of the drawing are, for example, different possible geometries of the sound absorber bodies 10, wherein the sound absorber 9 is preferably composed of sound absorber bodies 10 of identical geometry.

It is understood that the foregoing description is that of the preferred embodiments of the invention and that various changes and modifications may be made thereto without departing from the spirit and scope of the invention as defined in the appended claims.

### LIST OF REFERENCE SIGNS

(Part of the description)

1 Tread

2 Sidewall

3 Bead region

4 Bead core

5 Belt assembly

6 Carcass insert

7 Inner layer

8 Sealant layer

9 Inner absorber/sound absorber

10 Sound absorber body

11 Diameter of the sound absorber body

12 Layer thickness of the sealant

What is claimed is:

1. A pneumatic vehicle tire comprising:
a tire body having a tread and defining an interior and an inner surface arranged opposite to said tread;
a sound absorber made of foam adhesively attached, in said interior of said tire body, to said inner surface arranged opposite said tread;
a self-sealing sealant;
said sound absorber adhering to said self-sealing sealant which is previously applied and, at least immediately after its application, having a tackiness required for the adhesive attachment of said sound absorber;
said sound absorber including a multiplicity of individual geometric sound absorber bodies which are not connected to one another;
each of said geometric sound absorber bodies adhering to said sealant; and,
each of said geometric sound absorber bodies having a diameter lying in a range of 1 mm to 70 mm.

2. The pneumatic vehicle tire of claim 1, wherein said sound absorber bodies are geometrically regular bodies.

3. The pneumatic vehicle tire of claim 2, wherein said geometrically regular bodies each have a diameter lying in a range of 10 mm to 70 mm.

4. The pneumatic vehicle tire of claim 2, wherein said geometrically regular bodies each have a diameter lying in a range of 20 mm to 40 mm.

5. The pneumatic vehicle tire of claim 2, wherein said geometrically regular bodies include at least one of spheres or polyhedra.

6. The pneumatic vehicle tire of claim 1, wherein said sound absorber bodies are geometrically irregular bodies.

7. The pneumatic vehicle tire of claim 6, wherein said geometrically irregular bodies each have a diameter lying in a range of 10 mm to 70 mm.

8. The pneumatic vehicle tire of claim 6, wherein said geometrically irregular bodies each have a diameter lying in a range of 20 mm to 40 mm.

9. The pneumatic vehicle tire of claim 1, wherein said sealant is a polyurethane gel.

10. The pneumatic vehicle tire of claim 1, wherein said sealant is a viscous mixture based on a butyl rubber, a polybutene or based on silicone.

11. The pneumatic vehicle tire of claim 1, wherein said sealant has a layer thickness lying in a range between 2 mm and 5 mm.

12. The pneumatic vehicle tire of claim 1, wherein said sealant has a layer thickness of approximately 3.5 mm.

13. The pneumatic vehicle tire of claim 1, wherein said sound absorber bodies within a tire are either of equal sizes or of different sizes.

14. The pneumatic vehicle tire of claim 1, wherein said sound absorber bodies are arranged in such a number that, in a projection onto said sound absorber bodies, 30% to 95% of said inner surface situated opposite the tread is covered with sound absorber bodies.

15. The pneumatic vehicle tire of claim 1, wherein said sound absorber bodies are arranged in such a number that, in a projection onto said sound absorber bodies, 70% to 90% of said inner surface situated opposite the tread is covered with sound absorber bodies.

16. A method for producing a pneumatic vehicle tire, the pneumatic vehicle tire having a tread and an inner layer and defining an interior space and an inner surface arranged opposite to the tread; the pneumatic vehicle tire further including a self-sealing sealant and a sound absorber made of foam adhesively attached, in the interior space of the tire, to the inner surface arranged opposite the tread; the sound absorber adhering to the self-sealing sealant which is previously applied and, at least immediately after its application, having a tackiness required for the adhesive attachment of the sound absorber; the sound absorber including a multiplicity of individual geometric sound absorber bodies which are not connected to one another; each of the geometric sound absorber bodies adhering to the sealant; and, each of the geometric sound absorber bodies having a diameter lying in a range of 1 mm to 50 mm; the method comprising the steps of:
applying an annular sealant layer on the inner layer of the tire;
pouring a sufficient number of geometric sound absorber bodies into the interior space; and,
rotating the tire such that the geometric sound absorber bodies adhere to the annular sealant layer.

17. A pneumatic vehicle tire comprising:
a tire body having a tread and defining an interior and an inner surface arranged opposite to said tread;
a sound absorber made of foam adhesively attached, in said interior of said tire body, to said inner surface arranged opposite said tread;
a self-sealing sealant;
said sound absorber adhering to said self-sealing sealant which is previously applied and, at least immediately after its application, having a tackiness required for the adhesive attachment of said sound absorber;
said sound absorber including a multiplicity of individual geometric sound absorber bodies which are not connected to one another;
each of said geometric sound absorber bodies adhering to said sealant; and,
each of said geometric sound absorber bodies having a diameter lying in a range of 1 mm to 50 mm.
